(19) United States
(12) Patent Application Publication
(10) Pub. No.: US 2012/0005564 A1
(43) Pub. Date: Jan. 5, 2012

(54) CONTENT DISTRIBUTION SYSTEM AND METHOD

(75) Inventor: Hisayoshi TSUBAKI, Tokyo (JP)

(73) Assignee: FUJIFILM CORPORATION, Tokyo (JP)

(21) Appl. No.: 13/172,669

(22) Filed: Jun. 29, 2011

(30) Foreign Application Priority Data
Jul. 2, 2010 (JP) JP2010-151688

(51) Int. Cl. G06F 17/00

(52) U.S. Cl. 715/204

(57) ABSTRACT

A content distribution system comprising an anchor point information generation unit to analyze anchor points that are positions at which a reader's visual line stops and a transition order of the anchor points with respect to original contents in accordance with a specific analytical rule corresponding to the original contents and generate anchor point information indicating the analyzed anchor points and the transition order of the anchor points.

### BACKGROUND OF THE INVENTION

1. Field of the Invention

The present invention relates to a device and a method for displaying various types of digitized contents that are originally paper-based contents such as a comic, a newspaper, a magazine, and a document.

2. Description of the Related Art

According to Japanese Patent Application Laid-Open No. 2007-226255, a reproduction order in each frame of a comic is set based on the order assumed as a frame sequence by a writer of the comic. For example, each of the frames includes identification numbers, and the reproduction order is set as data of the sequence of the identification numbers. In order to make it easy to read a frame with a screen size of a display device to reproduce, when there is a single large frame occupying the whole page, a plurality of display positions may be set on the single large frame, and then each of the display positions may be newly set as a frame.

According to Japanese Patent Application Laid-Open No. 2007-164550, a file of Flash comic contents is created based on the set frame display order. The creation of the Flash content file is performed by causing a personal computer to execute a specific Flash creation application in accordance with a content provider's instructions, and the Flash content file including image data and a frame display order instruction (frame display sequence) of a corresponding page is created for each page.

In addition to the above, Japanese Patent Application Laid-Open No. 2001-25024 and Japanese Patent Application Laid-Open No. 11-272399 are considered as related arts of the present invention.

### SUMMARY OF THE INVENTION

As discussed in Japanese Patent Application Laid-Open No. 2007-226255 and Japanese Patent Application Laid-Open No. 2007-164550, it is very complicated for a user to preliminarily determine frame sequences manually for each frame and input the frame sequence as data. In addition, in the related arts, there is no mention about a device in which digitized contents are sequentially distributed to terminals having a variety of specifications and forms in accordance with the data of the digitized contents and reproduced by the terminals having a variety of specifications and forms.

The present invention provides a technique for determining a display order of a digitized book automatically and distributing the digitized books to terminals having a variety of specifications and forms in accordance with the determined display order.

The present invention provides a content distribution system including:

an input unit to which original contents are input;

a content analysis unit to analyze the original contents input by the input unit and obtain content analysis information that is information about the original contents;

an anchor point information generation unit to analyze anchor points that are positions at which a reader's visual line stops and a transition order of the anchor points with respect to the original contents input by the input unit in accordance with a specific analytical rule corresponding to the original contents input by the input unit, and generate anchor point information indicating the analyzed anchor points and the transition order of the anchor points;

a conversion unit to convert the original contents input from the input unit into distribution contents that are images based on the anchor point information and a model of a terminal;

an information embedding unit to embed the anchor point information generated by the anchor point information generation unit into the distribution contents converted by the conversion unit;

a content database to store the distribution contents in which the information embedding unit embeds the anchor point information, for each model of the terminal;

a scenario generation unit to determine a stop time of the distribution contents for each of the anchor points generated by the anchor point information generation unit based on at least one of the model of the terminal and the content analysis information, and generate a scenario indicating the determined stop time for each of the anchor points; and

a distribution unit to extract a scenario and distribution contents corresponding to a model of a terminal which accesses, from the database and distribute the scenario and the distribution contents to the terminal.

In the content distribution system, the scenario generation unit determines display magnification of the distribution contents for each of the anchor points generated by the anchor point information generation unit based on specifications of the terminal including a screen size and generates a scenario indicating the determined display magnification for each of the anchor points.

In the content distribution system, the scenario generation unit determines a stop time of the contents for each of the anchor points generated by the anchor point information generation unit based on an amount of information of contents around the anchor points and generates a scenario indicating the determined stop time for each of the anchor points.

In the content distribution system, the scenario generation unit determines a stop time of the contents for each of the anchor points generated by the anchor point information generation unit based on past reproduction conditions of the contents corresponding to the anchor points in the terminal and generates a scenario indicating the determined stop time for each of the anchor points.

In the content distribution system, the reproduction conditions of the contents include reproduction conditions of the contents by a specific user.

In the content distribution system, the reproduction conditions of the contents include reproduction conditions of the contents by public users.

In the content distribution system, based on one of a size and an amount of distribution contents corresponding to a current anchor point that is an anchor point currently being reproduced in the terminal, the distribution unit distributes distribution contents corresponding to anchor points subsequent to the current anchor point.

The content distribution system further includes a terminal to receive the scenario and the distribution contents from the distribution unit and reproduce the distribution contents in accordance with the scenario.

The present invention provides a content distribution method performed by a computer comprising the steps of:

receiving original contents as an input;

analyzing the input original contents, and obtaining content analysis information that is information about the original contents;

analyzing anchor points that are positions at which a reader's visual line stops and a transition order of the anchor points with respect to the input original contents in accordance with a specific analytical rule corresponding to the input original contents, and generating anchor point information indicating the analyzed anchor points and the transition order of the anchor points;

converting the input original contents into distribution contents that are images based on the anchor point information and a model of a terminal;

embedding the generated anchor point information into the converted distribution contents:

storing the distribution contents embedded with the anchor point information in a database, for each model of the terminal;

determining a stop time of the distribution contents for each of the generated anchor points based on at least one of the model of the terminal and the content analysis information, and generating a scenario indicating the determined stop time for each of the anchor points; and

extracting a scenario and distribution contents corresponding to a model of a terminal which accesses, from the database and distributing the scenario and the distribution contents to the terminal.

The present invention also provides a non-transitory computer-readable medium having embodied thereon a computer program which executed by a content distribution system cause the content distribution system to perform this content distribution method.

According to the invention, anchor point information that is information including a stop position of a visual line and a transition order of the visual line obtained based on analyzed results of contents, a scenario that is based on the model of a terminal and indicates a stop time in the contents for each anchor point, and reproduction contents based on the model of the terminal can be transmitted to the terminal. The terminal that has received the anchor point information, the scenario, and the reproduction contents can reproduce the reproduction contents based on the model of the terminal in accordance with the scenario based on the model of the terminal.

### BRIEF DESCRIPTION OF THE DRAWINGS

FIG. 1 illustrates a schematic diagram of a content distribution system;

FIGS. 2A to 2C illustrate examples of an anchor point;

FIG. 3 illustrates a flowchart of scenario generation processing;

FIG. 4 illustrates a flowchart of distribution processing; and

FIGS. 5A to 5C illustrate examples of original contents, anchor point information, and a detailed image.

### DETAILED DESCRIPTION OF THE PREFERRED EMBODIMENTS

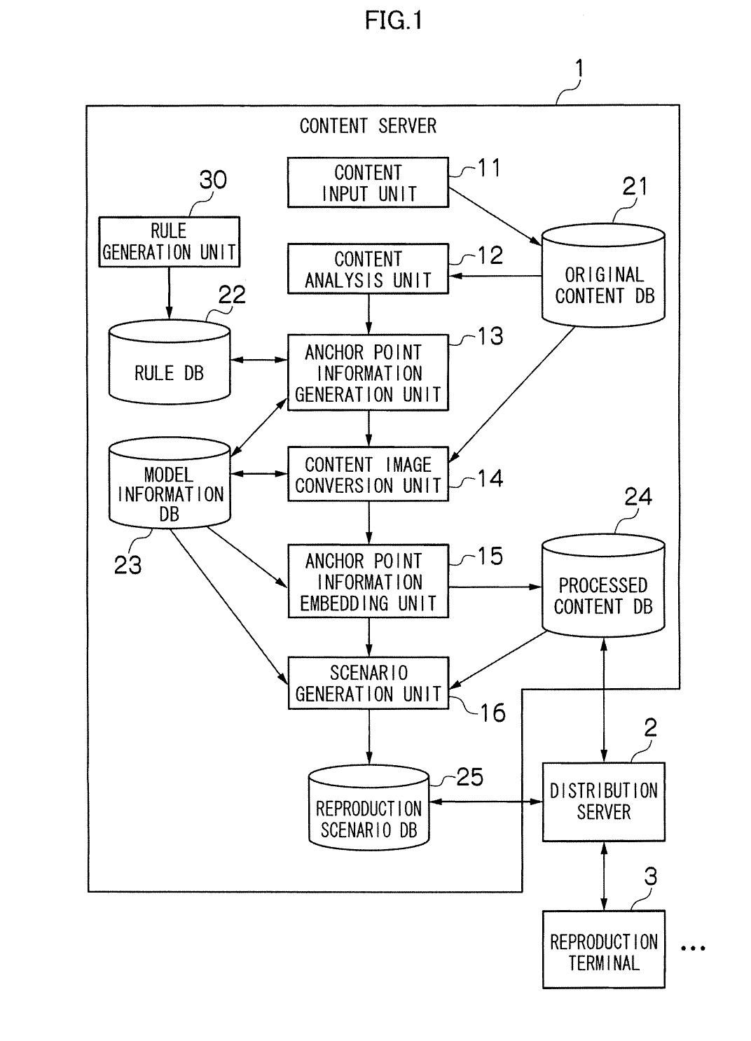

FIG. 1 illustrates configuration of a content distribution system according to a preferred embodiment of the present invention. The system includes a content server 1 and a distribution server 2. Each of the content server 1 and the distribution server 2 is configured by a computer (information processing device) provides with, a central processing unit (CPU), a storage device, an input/output (I/O) circuit, etc. The content server 1 and the distribution server 2 may be included in a single computer.

The content server 1 includes a content input unit 11, a content analysis unit 12, a anchor point information generation unit 13, a content image conversion unit 14, an anchoring information embedding unit 15, a scenario generation unit 16, an original content DB 21, a rule DB 22, a model information DB 23, a processed content DB 24, and a reproduction scenario DB 25.

The content input unit 11 receives, as an input, original contents set per page unit such as a comic, a newspaper, articles of a weekly magazine, or an office document (a document for presentation, etc). An arbitrary input form is available, and the original contents can be input through a network such as Universal Serial Bus (USB) and the Internet, or through a computer-readable recording medium such as a memory card and a compact disc-read-only memory (CD-ROM). The input original contents are accumulated in the original content DB 21. The input original contents accumulated in the original content DB 21 are data digitized by a scanner, etc. An arbitrary storage form is available for the original contents, and the original contents are stored in the form of a PDF file or an image file, etc. Additional information may be recorded into the original contents. The additional information can include a content writer, a title, total number of pages, volume number, episode number, etc.

The content analysis unit 12 analyzes the original contents and the additional information of the original contents that are accumulated in the original content DB 21, and outputs content analysis information. The content analysis information includes a content type (a comic, a newspaper, articles of a weekly magazine, an office document, etc.), a content writer, a content title, an episode number in a case where contents are series configured by a plurality of volumes or episodes, the number of pages of contents, layout of content elements (a frame, a drawing, a type of an appearing character in drawings, a word balloon, a text, a chart, a figure, etc.) for each page, feature of a character (a character name, a character's visual line direction, size of the character, position of the character, etc.), contents of text, position of text, an amount of text (the number of letters), and break of page/section/chapter. A position, a size, and a type of the content elements may be automatically detected based on feature quantity of an object (face, etc). The automatic detection of the content elements may be performed based on machine learning.

The rule DB 22 accumulates anchor point generation rules. For example, the rule DB 22 accumulates anchor point generation rules based on a type of contents.

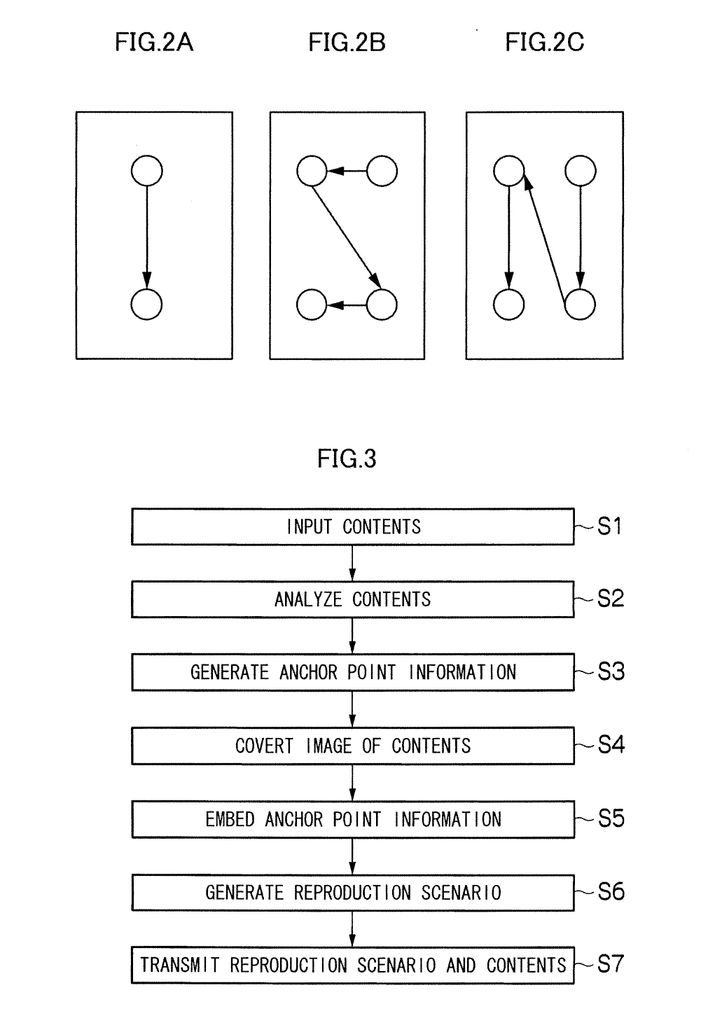

More specifically, as illustrated in FIG. 2A, when a type of contents is an office document with horizontal typesetting, a rule for sequentially scanning a representative point (a center point or important point of a frame, etc.) for each frame from a text at the upper most position to a text at the lowest position that are included in the content analysis information is accumulated as an anchor point generation rule A.

In addition, as illustrated in FIG. 2B, when a type of contents is a comic, a rule for sequentially scanning, in a horizontal direction, a representative point (a center point or gravitational point of a frame, etc.) for each frame from a frame (or a word balloon) at the upper most right position to a frame (or a word balloon) at the lowest left position that are included in the content analysis information is accumulated as an anchor point generation rule B.

In addition, as illustrated in FIG. 2C, when a type of contents is a newspaper with vertical typesetting, a rule for sequentially scanning, in a vertical direction, a representative point for each frame from a position at the upper most right to that at the lowest left that are included in the content analysis information is accumulated as an anchor point generation rule C.

Alternatively, although not illustrated herein, an anchor point generation rule depending on a writer of contents can be accumulated in the rule DB 22.

Alternatively, in the rule DB 22, in addition to specific rules based on a writer of contents or a type of contents, rules based on a writer of contents or a type of contents learned by artificial intelligence in a rule generation unit 30 may be accumulated.

The rule learning in the rule generation unit 30 is, for example, performed as follows. First, a correct rule for each plurality of basic patterns is preliminarily prepared. The rule generation unit 30 extracts feature quantities (thickness and length of a frame border line, etc.) for each the plurality of basic patterns. In addition, the rule generation unit 30 estimates the reading order of frames assumed by a writer of contents, from the extracted feature quantities. The rule generation unit 30 compares the reading order estimated for each of the basic patterns with the correct rule, and optimizes a parameter that estimates the frame-reading order. The optimized parameter is stored in the rule DB 22.

The anchor point information generation unit 13 generates anchor point information based on content analysis information output by the content analysis unit 12 and anchor point generation rules accumulated in the rule DB 22. An anchor point is a position (eye-stop) where a visual line stops for each of the elements of contents per page. The anchor point information generation unit 13 extracts an anchor point rule corresponding to a type of input content from among anchor point generation rules for each type of contents that are accumulated in the rule DB 22, generates anchor point information in accordance with the extracted anchor point generation rule and content analysis information.

The anchor point information includes information indicating the position coordinate of an anchor point and a movement order or movement direction of each anchor point. The anchor point information may include other various types of option information.

The content image conversion unit 14 converts the original contents accumulated in the original content DB 21 into images in a format reproducible in a reproduction terminal. The converted images are called reproduction contents. The format reproducible in a reproduction terminal is JPEG, etc. In addition, the content image conversion unit 14 identifies screen size information corresponding to the model information of a reproduction terminal 3 that has accessed the distribution server 2 based on the model information DB 23, and resizes the resolution of the reproduction contents in order to be applied to the identified screen information, so that the reproduction contents are created. In this case, the content image conversion unit 14 may be provided in the reproduction terminal 3 not the content server 1.

Alternatively, the content image conversion unit 14 resizes resolution of the reproduction contents based on screen size information for each terminal model accumulated in the model information DB 23 and creates the reproduction contents for each of the terminal models.

The reproduction contents include an overview image and a detailed image. The overview image is a low-definition image that schematically represents the whole contents per page. A detailed image is one or more high-definition image that corresponds to each eye-stop and illustrates a content element around an anchor point in detail. For example, the detailed image is a high-definition image for each one frame portion in a comic in which each of the anchor points defined based on the content analyzed results is regarded as a representative point.

The anchoring information embedding unit 15 embeds the anchor point information generated by the anchor point information generation unit 13 in the reproduction contents, for each of the terminal models, converted by the content image conversion unit 14. An arbitrary way of embedding is available in the anchoring information embedding unit 15. For example, meta data in an XML format is associated with the reproduction contents. The reproduction contents embedded in the anchor point information are accumulated in the processed content DB 24 for each piece of model information.

A scenario generation unit 16 generates a reproduction scenario corresponding to reproduction contents in the processed content DB 24 based on content analysis information/model information/reproduction state information. The generated scenario is accumulated in the reproduction scenario DB 25. An arbitrary storage format of the scenario is available, for example, the scenario is described in XML similar to anchoring information. The reproduction scenario may corresponds to the whole contents or may corresponds to the contents for each page, however, the reproduction scenario corresponding to the content for each of the pages needs to be distributed together with an overview image each time the overview image in each of the pages is transmitted.

A reproduction scenario includes magnification of a detailed image, display switching speed and a display switching method (scroll, fade-out/fade-in, etc.) for switching from a detailed image corresponding to a prior anchor point to a detailed image corresponding to a next anchor point, a stop time of a visual line in each anchor point, that is, a stop time that is length of display time of a detailed image corresponding to each of the anchor points, location (page and section) of an overview image and a detailed image in contents, heading information, etc.

For example, a stop time to be adapted for an amount of text in a detailed image corresponding to each anchor point is set in the reproduction scenario. As an amount of text in the detailed image around each of the anchor points becomes large, an amount of information in one screen increases by a corresponding amount, so that the stop time is set longer in the reproduction scenario by a corresponding time.

Alternatively, a stop time for each terminal model to adapt magnification of a detailed image in each anchor point, for a screen size for each reproduction terminal 3 that accesses the distribution server 2 or each terminal model stored in the model information DB 23 is set in the reproduction scenario.

Alternatively, display switching speed between anchor points is set in the reproduction scenario. The display switching speed may be decided based on display switching speed that is in a prior reading operation and is obtained as reproduction state information and corresponds to a user of the reproduction terminal 3 who has accessed the distribution server 2, or may be decided by applying display switching speed in a prior reading operation obtained from a plurality of the reproduction terminal 3 that have reproduced same reproduction contents as reproduction state information, to a specific arithmetic expression (average, etc).

A display switching method may be a specific default switching method, or may be set based on content analysis information. For example, in contents, if a destination point of a character's visual line direction in a certain frame “a” matches with a destination point in a frame “b” that is in the direction of anchor points, display switching method from the frame “a” to the frame “b” is set in a scroll operation.

Location (page and section) of an overview image and a detailed image in contents, and heading information, etc. correspond to additional information of original contents.

The distribution server 2 extracts a reproduction scenario and reproduction contents corresponding to model information of the reproduction terminal 3 connected through a network such as the Internet, from the reproduction scenario DB 25 and the processed content DB 24, respectively, and transmits the extracted reproduction scenario and image to the reproduction terminal 3. The reproduction scenario and the reproduction contents may be transmitted all together, or may be transmitted per reproduction unit (page, etc).

The reproduction terminal 3 is configured by a mobile-type information terminal such as a mobile phone, and provided with an information processing device, a display device, and a communication device that can reproduce each image. The reproduction terminal 3 reproduces an image based on the reproduction scenario received from the distribution server 2. There are any number of reproduction terminals 3 to access the distribution server 2 and users of the reproduction terminals 3.

FIG. 3 illustrates a flowchart of scenario generation processing performed by the content server 1. A program causes the content server 1 to execute the processing is stored in a non-transitory computer-readable recording medium such as a random access memory (RAM), a read-only memory (ROM), and a CD-ROM that are included in the content server 1.

In S1, original contents are input by the content input unit 11.

In S2, the content analysis unit 12 analyzes the original contents.

In S3, the anchor point information generation unit 13 generates anchor point information.

In S4, the content image conversion unit 14 converts the original contents into reproduction contents for each piece of model information.

In S5, the anchoring information embedding unit 15 embeds the anchor point information in the reproduction contents. The reproduction contents in which the anchor point information is embedded are accumulated in the processed content DB 24 with respect to model information.

In S6, the scenario generation unit 16 generates a reproduction scenario for each piece of model information.

In S7, the distribution server 2 transmits the reproduction scenario and reproduction contents that correspond to the model information of the reproduction terminal 3, to the reproduction terminal 3.

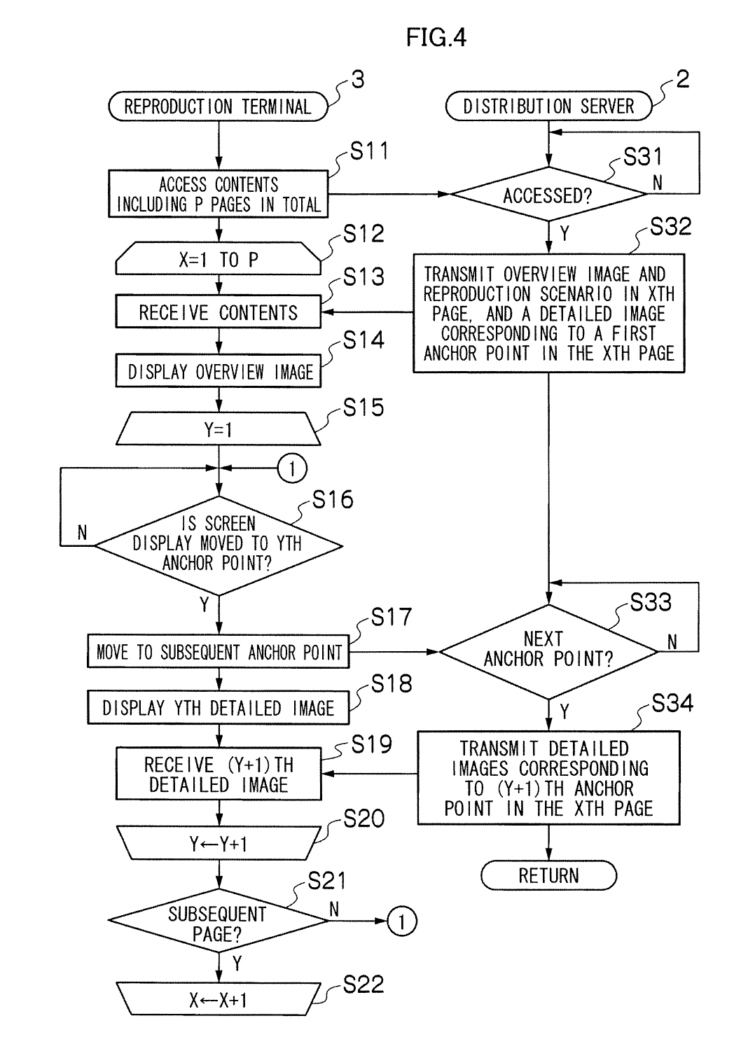

FIG. 4 illustrates a flowchart of distribution processing performed between the reproduction terminal 3 and the distribution server 2. Processing in S11 to S22 is performed by the reproduction terminal 3, and processing in S31 to S34 is performed by the distribution server 2. A program that causes the distribution server 2 or the reproduction terminal 3 to respectively execute the processing is stored in a non-transitory computer-readable recording medium such as RAM, ROM, and CD-ROM provided in each of the distribution server 2 and the reproduction terminal 3.

Processing at the reproduction terminal 3 is as follows. It is noted that there can exist any number of reproduction terminals 3 connected to the distribution server 2.

In S11, the reproduction terminal 3 accesses the distribution server 2 in response to a distribution request operation from a user and performs a distribution request of reproduction contents including P pages in total, to the distribution server 2. The distribution request includes identification information of the model of the reproduction terminal 3. The “P” indicates the number of total pages corresponding to the (reproduction) contents and is obtained by the content analysis unit 12.

In S12, the reproduction terminal 3 sets a value of “X” in order of “X=1, 2, . . . , P” and repeats a loop of processing in S12 to S22 each time.

In S13, the reproduction terminal 3 receives an overview image in Xth page of the reproduction contents including P pages in total, a detailed image corresponding to a first anchor point and reproduction scenario in the Xth page, and stores the overview image, the reproduction scenario, and the detailed images in a storage medium such as a RAM and a memory card.

In S14, the reproduction terminal 3 receives the overview image in the desired Xth page (for example, X=1) corresponding to the model information of the reproduction terminal 3, the reproduction scenario of the Xth page, and the detailed image corresponding to the first anchor point in the Xth page that are transmitted from the distribution server 2.

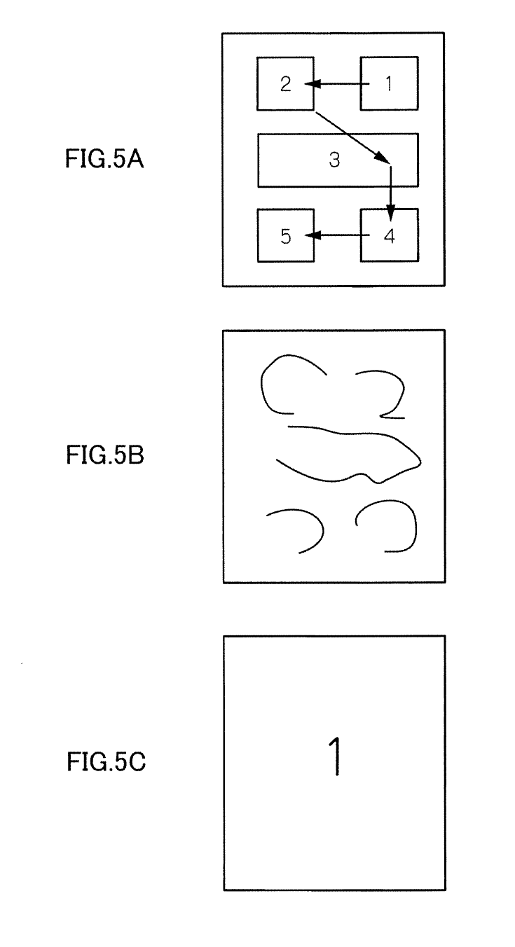

In S14, the reproduction terminal 3 displays the overview image in the Xth page that corresponds to the model information of the reproduction terminal 3 and that is received from the distribution server 2, on a screen. FIG. 5A illustrates an example of reproduction contents corresponding to Xth page and anchor point information embedded in the reproduction contents, and FIG. 5B illustrates an example of an overview image corresponding to Xth page. It is noted that, in practice, anchor point information embedded in reproduction contents is invisible.

In S15, the reproduction terminal 3 sets a value of “Y” in order of “Y=1, 2, . . . , q” and repeats a loop of processing in S15 to S20. The “q” indicates the number of total frames corresponding to the Xth page currently being displayed and is obtained by the content analysis unit 12.

In S16, the reproduction terminal 3 determines whether or not an anchor point movement event that is an event where screen display is moved to a Yth (for example, Y=1) anchor point in Xth page has occurred. When the reproduction terminal 3 determines an anchor point movement event has occurred, the processing proceeds to S17. For example, when a stop time in the anchor point currently being displayed that is defined in the reproduction scenario elapses, the reproduction terminal 3 determines an anchor point movement event has occurred. Even before the stop time elapses, when movement to a next anchor point is instructed by a user operation, the reproduction terminal 3 determines an anchor point movement event has occurred.

In S17, the reproduction terminal 3 performs a distribution request of all or part of detailed images corresponding to (Y+1)th and subsequent anchor points in the Xth page corresponding to the model information of the reproduction terminal 3 by accessing the distribution server 2. The detailed images corresponding to the (Y+1)th and subsequent anchor points are identified by the anchor point information and the reproduction scenario.

In S18, the reproduction terminal 3 displays an detailed image corresponding to a Yth anchor point in Xth page corresponding to the model information of the reproduction terminal 3, on the screen. In FIG. 5C, a detailed image corresponding to a first anchor point is displayed on a screen as an example. A magnification and a stop time of the displayed detailed image are in accordance with the reproduction scenario, alternatively, the magnification can be arbitrary-modified by the user operation.

In S19, the reproduction terminal 3 receives all or part of the detailed images corresponding to (Y+1)th and subsequent anchor points in the Xth page corresponding to the model information of the reproduction terminal 3, from the distribution server 2, and stores the detailed images in the storage medium. An amount of the detailed image received by the reproduction terminal 3 is described later.

In S20, the reproduction terminal 3 increments “Y” by one.

In S21, the reproduction terminal 3 determines whether or not an instruction to switch a display to (X+1)th page is input from a user. When the reproduction terminal 3 determines an instructions to switch a display to (X+1)th page is input from a user, the processing proceeds to S22. When the reproduction terminal 3 determines an instruction to switch a display to (X+1)th page is not input from a user, the processing returns to S16.

In S22, the reproduction terminal 3 increments “X” by one. After that, the processing returns to S12.

Processing at the distribution server 2 is as follows.

In S31, the distribution server 2 determines whether or not a distribution request of reproduction contents including P pages in total is received from the reproduction terminal 3. When the distribution server 2 determines a distribution request of reproduction contents including P pages in total is received from the reproduction terminal 3, the processing proceeds to S32.

In S32, the distribution server 2 obtains an overview image in the Xth page of the reproduction contents including P pages in total corresponding to the model information of the reproduction terminal 3 and a detailed image corresponding to a first anchor point and reproduction scenario in the Xth page, from the processed content DB 24 and the reproduction scenario DB 25, respectively, and transmits the overview image, the reproduction scenario, and the detailed images back to the reproduction terminal 3 which has transmitted the distribution request.

In S33, the distribution server 2 determines whether or not a distribution request of a detailed image corresponding to a (Y+1)th anchor point in the Xth page corresponding to the model information of the reproduction terminal 3 is received. When the distribution server 2 determines a distribution request of a detailed image corresponding to a (Y+1)th anchor point in the Xth page corresponding to the model information of the reproduction terminal 3 is received, the processing proceeds to S34.

In S34, the distribution server 2 obtains detailed images corresponding to (Y+1)th and subsequent anchor points in the Xth page corresponding to the model information of the reproduction terminal 3, from the processed content DB 24, and transmits the detailed images to the reproduction terminal 3. The distribution server 2 determines whether the only detailed image corresponding to the (Y+1)th anchor point is transmitted, or all or part of the detailed images corresponding to the (Y+1)th, (Y+2)th and subsequent anchor points are transmitted, from among the detailed images corresponding to the (Y+1)th and subsequent anchor points, based on a capacity (size) of the Yth detailed image in the Xth page, or an amount of text or stop time in the detailed image corresponding to the Yth anchor point in the Xth page.

For example, when a capacity (size) of the Yth detailed image in the Xth page is large, the distribution server 2 determines that remaining capacity of the storage medium in the reproduction terminal 3 is small and transmits an only detailed image corresponding to the (Y+1)th and subsequent anchor points. On the other hand, when the capacity (size) of the detailed image corresponding to the Yth anchor point in the Xth page is small, the distribution server 2 determines that the remaining capacity of the storage medium in the reproduction terminal 3 is large and transmits detailed images corresponding to the two or more (Y+1)th and subsequent anchor points.

Alternatively, when the amount of the text or stop time that corresponds to the Yth anchor point in the Xth page is large, the distribution server 2 transmits detailed images corresponding to the two or more (Y+1)th and subsequent anchor points because there is enough time to move to the (Y+1)th anchor point. On the other hand, when the amount of the text or capacity (size) of the stop time that correspond to the Yth anchor point in the Xth page is small, the distribution server 2 transmits the only detailed image corresponding to the (Y+1)th anchor point because there is not enough time to move to the (Y+1)th anchor point.

The reproduction terminal 3 may also be used for determining that the size of the remaining capacity of the storage medium in the reproduction terminal 3 instead of the distribution server 2. Thus, the reproduction terminal 3 can also determine the size of the remaining capacity of the storage medium in the reproduction terminal 3 similar to the distribution server 2. In addition, the reproduction terminal 3 can also request, to the distribution server 2, transmission of the only detailed image corresponding to the (Y+1)th and subsequent anchor points or more detail images, based on the determination result, and the distribution server 2 can also transmit the detailed images to the reproduction terminal 3 based on the request.

Here, the processes in S31 to S34 are repeated until reproduction scenarios corresponding to the above-described contents and all overview images and all detailed images corresponding to all pages are transmitted as long as a distribution request from the reproduction terminal 3 is performed.

As described above, contents corresponding to the model information of the reproduction terminal 3 are transmitted from the distribution server 2 to the reproduction terminal 3 based on the transition of the anchor points. In this case, prior distribution of contents corresponding to subsequent anchor points is performed based on a capacity of contents corresponding to a current anchor point, or an amount of the text or stop time that correspond to the current anchor point in the contents, thereby enabling proper distribution management based on the reproduction terminal 3.

What is claimed is:

1. A content distribution system comprising:
an input unit to input original contents;
a content analysis unit to analyze the original contents input by the input unit and obtain content analysis information that is information about the original contents;
an anchor point information generation unit to analyze anchor points that are positions at which a reader's visual line stops and a transition order of the anchor points with respect to the original contents input by the input unit in accordance with a specific analytical rule corresponding to the original contents input by the input unit, and generate anchor point information indicating the analyzed anchor points and the transition order of the anchor points;
a conversion unit to convert the original contents input from the input unit into distribution contents that are images based on the anchor point information and a model of a terminal;
an information embedding unit to embed the anchor point information generated by the anchor point information generation unit into the distribution contents converted by the conversion unit;
a content database to store the distribution contents in which the information embedding unit embeds the anchor point information, for each model of the terminal;
a scenario generation unit to determine a stop time of the distribution contents for each of the anchor points generated by the anchor point information generation unit based on at least one of the model of the terminal and the content analysis information, and generate a scenario indicating the determined stop time for each of the anchor points; and
a distribution unit to extract a scenario and distribution contents corresponding to a model of a terminal which accesses from the database and distribute the scenario and the distribution contents to the terminal.

2. The content distribution system according to claim 1, wherein
the scenario generation unit determines display magnification of the distribution contents for each of the anchor points generated by the anchor point information generation unit based on specifications of the terminal including a screen size and generates a scenario indicating the determined display magnification for each of the anchor points.

3. The content distribution system according to claim 1, wherein
the scenario generation unit determines a stop time of the contents for each of the anchor points generated by the anchor point information generation unit based on an amount of information of contents around the anchor points and generates a scenario indicating the determined stop time for each of the anchor points.

4. The content distribution system according to claim 1, wherein
the scenario generation unit determines a stop time of the contents for each of the anchor points generated by the anchor point information generation unit based on past reproduction conditions of the contents corresponding to the anchor points in the terminal and generates a scenario indicating the determined stop time for each of the anchor points.

5. The content distribution system according to claim 4, wherein
the reproduction conditions of the contents include reproduction conditions of the contents by a specific user.

6. The content distribution system according to claim 4, wherein
the reproduction conditions of the contents include reproduction conditions of the contents by public users.

7. The content distribution system according to claim 1, wherein
based on one of a size and an amount of distribution contents corresponding to a current anchor point that is an anchor point currently being reproduced in the terminal, the distribution unit distributes distribution contents corresponding to anchor points subsequent to the current anchor point.

8. The content distribution system according to claim 1 further comprising:
a terminal to receive the scenario and the distribution contents from the distribution unit and reproduce the distribution contents in accordance with the scenario.

9. A content distribution method performed by a computer comprising the steps of:
inputting original contents;
analyzing the input original contents, and obtaining content analysis information that is information about the original contents;
analyzing anchor points that are positions at which a reader's visual line stops and a transition order of the anchor points with respect to the input original contents in accordance with a specific analytical rule corresponding to the input original contents, and generating anchor point information indicating the analyzed anchor points and the transition order of the anchor points;
converting the input original contents into distribution contents that are images based on the anchor point information and a model of a terminal;
embedding the generated anchor point information into the converted distribution contents;
storing the distribution contents embedded with the anchor point information in a database, for each model of the terminal;
determining a stop time of the distribution contents for each of the generated anchor points based on at least one of the model of the terminal and the content analysis information, and generating a scenario indicating the determined stop time for each of the anchor points; and
extracting a scenario and distribution contents corresponding to a model of a terminal which accesses, from the database and distributing the scenario and the distribution contents to the terminal.

10. A non-transitory computer-readable medium having embodied thereon a computer program which executed by a content distribution system cause the content distribution system to perform the content distribution method according to claim 9.
